(19) United States
(12) Patent Application Publication
(10) Pub. No.: US 2013/0139897 A1
(43) Pub. Date: Jun. 6, 2013

(54) REAL-TIME SYSTEM FOR MONITORING HYDROGEN TANK EXPANSION AND A METHOD FOR USING SAME

(71) Applicants: Sang Hyun Kim, Yongin (KR); Ki Ho Hwang, Yongin (KR); Ji Hyun Shim, Yongin (KR)

(72) Inventors: Sang Hyun Kim, Yongin (KR); Ki Ho Hwang, Yongin (KR); Ji Hyun Shim, Yongin (KR)

(73) Assignees: KIA MOTORS CORPORATION, Seoul (KR); HYUNDAI MOTOR COMPANY, Seoul (KR)

(21) Appl. No.: 13/494,486

(22) Filed: Jun. 12, 2012

(30) Foreign Application Priority Data
Dec. 1, 2011 (KR) 10-2011-0127488

(51) Int. Cl. F16K 37/00

(52) U.S. Cl. 137/2; 137/551

(57) ABSTRACT

The present disclosure provides a system and method for safely charging hydrogen using real-time hydrogen tank expansion data. The system includes an expansion measurement unit, a vehicle-side control unit, a charging station-side control unit, and a wireless communication unit. The expansion measurement unit is disposed on a hydrogen tank of the vehicle, and measures the degree of expansion of the hydrogen tank and generates a corresponding output signal. The vehicle-side control unit converts the output signal into data wireless output signal. The charging station-side control unit stops hydrogen replenishment by a hydrogen charger when the wireless output signal indicates an unsafe degree of tank expansion based. The wireless communication unit is provided to perform wireless data communication between the vehicle-side control unit and the charging-side control unit.

### CROSS-REFERENCE TO RELATED APPLICATION

This application claims under 35 U.S.C. §119(a) the benefit of Korean Patent Application No. 10-2011-0127488 filed Dec. 1, 2011, the entire contents of which are incorporated herein by reference.

### BACKGROUND

(a) Technical Field

The present invention relates to a system and method for safely replenishing hydrogen into a hydrogen tank of a fuel cell vehicle. More particularly, it relates to a system and method for more safely replenishing hydrogen into a hydrogen tank of a fuel cell vehicle using real-time tank expansion data.

(b) Background Art

Generally, internal combustion engine vehicles are driven by the rotational power of an internal combustion engine, which is generated from the combustion of fossil fuels with oxygen in the air, whereas fuel cell vehicles are driven by the rotational power of an electric motor driven by electric energy generated from a fuel cell stack. The fuel cell stack, which is the power source for fuel cell vehicles, generates electrical energy by electrochemically reacting hydrogen supplied from a high-pressure hydrogen tank or reformer with oxygen in the air supplied from an air supply device such as a blower or a compressor.

In such fuel cell vehicles, it is important to more safely and compactly store hydrogen, which is a fuel for the vehicle. Accordingly, various technologies for storing hydrogen have been developed to increase the driving distance and safety of fuel cell vehicles. For example, there are methods for liquefying gaseous hydrogen into liquid hydrogen and occluding gaseous hydrogen into a hydrogen-absorbing alloy. However, these methods currently have insoluble limitations in terms of the natural evaporation and the amount of occlusion that may occur. Accordingly, it is normal to add hydrogen into a lightweight and high-strength hydrogen tank that can withstand a high pressure. Also, hydrogen may be charged into a high-pressure tank to obtain sufficient riding space and driving distance.

Typical fuel cell vehicles use 350 bar or 700 bar hydrogen tanks. The bodies of the hydrogen tanks are formed of plastic or metal such as aluminum alloy, and then are wound with reinforcing materials such as carbon fiber to achieve sufficient pressure-withstanding performance.

Since high-pressure hydrogen is replenished into a hydrogen tank of a fuel cell vehicle at a charging station, the hydrogen tank repeatedly expands and contracts, which affects the durability lifespan of the hydrogen tank. The degree of expansion of a 750 bar hydrogen tank is greater than that of a 350 bar hydrogen tank. Also, the degree of expansion of a plastic tank is greater than that of a metallic tank such as, for example, an aluminum tank. Accordingly, when hydrogen is replenished into a tank at a high pressure without considering the expansion of the tank, accidents may occur such as, for example, bursting of the hydrogen tank and leakage of hydrogen and/or an explosion of the hydrogen tank.

In the conventional art, only the internal temperature and pressure of a hydrogen tank are being monitored during replenishment of the hydrogen tank to control the charging speed or interrupt the charging when the internal temperature or pressure exceeds a certain value. Since the expansion data of a hydrogen tank is not considered during hydrogen tank replenishment, the charging safety and the tank reliability cannot be insured. Additionally, the hydrogen tanks require frequent total inspection, which requires a lot of cost for tank inspection. Furthermore, since the charging safety and reliability of the hydrogen tank cannot be secured in real-time, mass-production of plastic hydrogen tanks is limited.

### SUMMARY OF THE DISCLOSURE

The present invention relates to a system and method for safely replenishing hydrogen in a hydrogen tank, by monitoring the real-time expansion data of the hydrogen tank while hydrogen is being replenished into the hydrogen tank of a fuel cell vehicle.

In one aspect, the present invention provides a system for safely replenishing hydrogen in a hydrogen tank using real-time tank expansion data, including: an expansion measurement unit installed at a hydrogen tank of a vehicle and configured to measure the degree of expansion of the hydrogen tank and to output a signal; a vehicle-side control unit configured to convert the output signal of the expansion measurement unit into wirelessly-transmittable data on the degree of hydrogen tank expansion; a charging station-side control unit configured to stop hydrogen replenishment by the a hydrogen charger when an unallowable degree of tank expansion is detected based on the data of the degree of hydrogen tank expansion received from the vehicle-side control unit; and a wireless communication unit provided to perform wireless data communication between the vehicle-side control unit and the charging-side control unit.

In another aspect, the present invention provides a method for safely replenishing hydrogen using real-time tank expansion data of a hydrogen tank of a fuel cell vehicle, the system including: measuring, by an expansion measurement unit installed at a hydrogen tank of the vehicle, the degree of expansion of the hydrogen tank during hydrogen replenishment; transmitting data on the degree of expansion of the hydrogen tank measured by the expansion measurement unit from a vehicle-side control unit to a charging station-side control unit through a wireless communication unit; and interrupting/stopping, by a charging station-side control unit, the replenishment of hydrogen by a hydrogen charger when an unallowable degree of hydrogen tank expansion is detected based on the data on the degree of expansion received from the vehicle-side control unit.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 is a view illustrating a connection state between a charging station and a fuel cell vehicle during hydrogen charging according to an exemplary embodiment of the present invention;

FIG. 2 is a view illustrating a configuration of a hydrogen safety charging system according to an exemplary embodiment of the present invention;

FIG. 3 is a perspective view illustrating a hydrogen tank with a strain gauge according to an exemplary embodiment of the present invention;

FIG. 4 is a perspective view illustrating a charging nozzle with an IR receiver according to an exemplary embodiment of the present invention;

FIG. 5 is a view illustrating a charging nozzle of a hydrogen charger connected to a receptacle of a vehicle according to an exemplary embodiment of the present invention; and

FIG. 6 is a flowchart illustrating a hydrogen safety charging method according to an exemplary embodiment of the present invention.

Reference numerals set forth in the Drawings includes reference to the following elements as further discussed below:

| | |
|---|---|
| 1: vehicle | 2: hydrogen tank |
| 3: receptacle | 10: strain gauge (expansion measurement |
| | unit) |
| 20: vehicle-side control unit | 30: wireless communication unit |
| 31: IR transmitter (wireless | 32: IR receiver (wireless receiver) |
| transmitter) | |
| 40: hydrogen charger | 41: charging station-side control unit |
| 42: hydrogen supply unit | 43: warning unit |
| 44: hydrogen supply hose | 45: charging nozzle |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles. The present invention relates to a system and method for more safely replenishing hydrogen into a hydrogen tank using real-time tank expansion data for the hydrogen tank of a fuel cell vehicle.

A system and method for safely replenishing hydrogen according to an embodiment of the present invention is configured to measure expansion of a hydrogen tank in real-time during hydrogen tank replenishment and allow a charging station to receive real-time expansion data of the tank from a vehicle through wireless communication. When the expansion data of the tank is determined to exceed a certain value, safe mode control such as stopping/interrupting hydrogen charging can be performed to prevent danger.

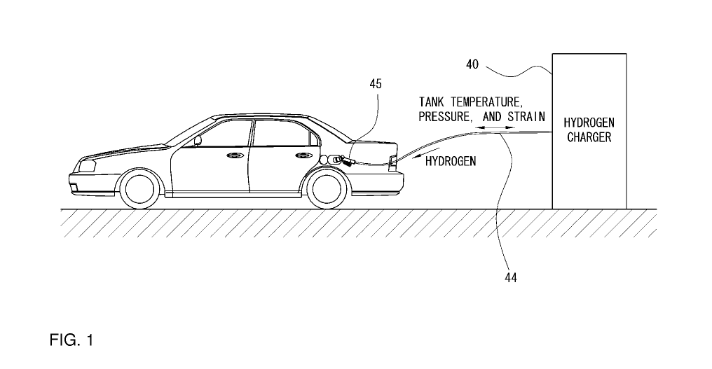

FIG. 1 is a view illustrating a connection state between a charging station and a fuel cell vehicle during hydrogen replenishment according to an exemplary embodiment of the present invention. If a charging nozzle 45 of a hydrogen supply hose 44 is connected to a vehicle 1, hydrogen may be supplied from a hydrogen charger 40 to the vehicle 1 through the hydrogen supply hose 44 and the charging nozzle 45. In this case, hydrogen may be replenished into a hydrogen tank (fuel tank) mounted in the vehicle 1 at high pressure.

During the replenishment of hydrogen, typical measurements such as internal temperature and pressure of the tank may be transmitted to the hydrogen charger 40, and expansion data (e.g., strain data measured by a strain gauge) of the tank measured in real-time by an expansion measurement unit of the hydrogen tank may be transmitted to the hydrogen charger 40.

The internal temperature and pressure of the tank may be typical data detected by a temperature detector and a pressure detector installed on a hydrogen tank. Here, a hydrogen charging interruption logic using the real-time expansion data of the tank and a typical logic for controlling the charging speed or stopping/interrupting hydrogen charging based on the internal temperature and pressure of the tank may be applied.

While high-pressure hydrogen is being replenished at a charging station, the hydrogen tank of the vehicle may expand in the longitudinal and circumferential directions. Such expansion may occur only during hydrogen charging. Accordingly, the present invention may be configured to perform a safety mode control for preventing danger when the expansion degree of the hydrogen tank exceeds a certain value by monitoring the degree of expansion of the hydrogen tank in real-time during the replenishment of hydrogen.

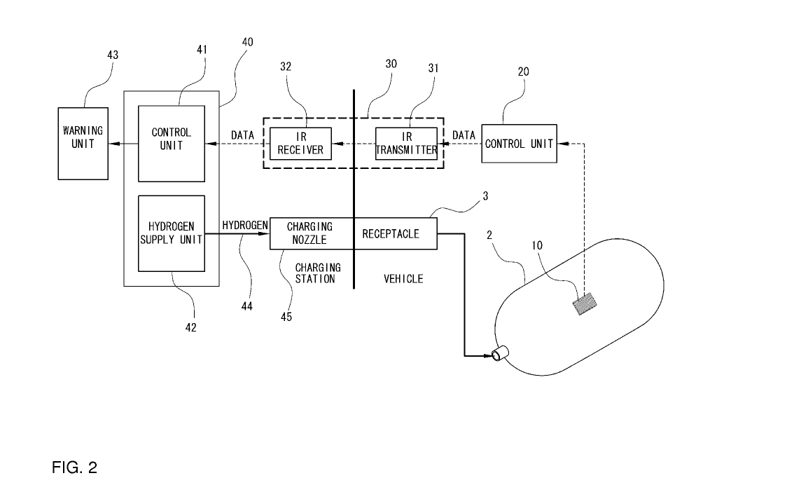

FIG. 2 is a view illustrating a configuration of a hydrogen safety charging system according to an exemplary embodiment of the present invention. The hydrogen safety charging system may include an expansion measurement unit 10, a vehicle-side control unit 20, a wireless communication unit 30, and a charging station-side control unit 41. The expansion measurement unit 10 may be attached to a hydrogen tank 2, and configured to measure and output the degree of expansion of the hydrogen tank 2 in real-time. The vehicle-side control unit 20 may convert the output signal of the expansion measurement unit 10 into wirelessly-transmittable data, and may output the wirelessly-transmittable data on the expansion degree of the hydrogen tank 2. The wireless communication unit 30 may be disposed for wireless transmission of data between the vehicle-side control unit 20 and the charging station-side control unit 41. The charging station-side control unit 41 may perform safety mode control when expansion of the hydrogen tank 2 exceeds a certain value based on the tank expansion data received by the wireless communication unit 30.

According to an exemplary embodiment, the expansion measurement unit 10 may be, for example, a strain gauge. The expansion measurement unit 10, which is attached to the wall of the hydrogen tank 2 to detect a strain of the tank wall during the charging of hydrogen may output electrical signals according to strain values detected by the expansion measurement unit 10,. The expansion measurement unit 10 may measure strains in two directions such as, for example, X and Y axes of the hydrogen tank.

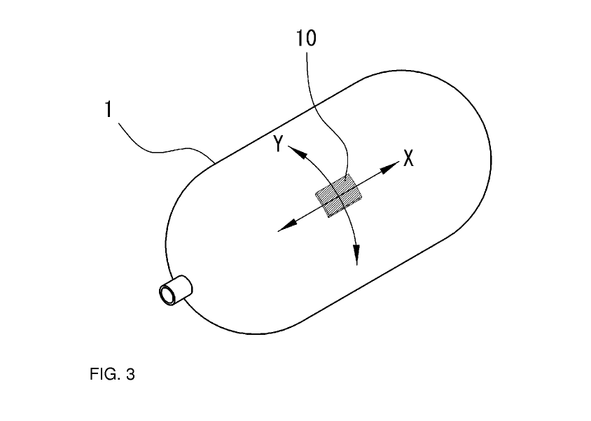

FIG. 3 is a perspective view illustrating a hydrogen tank with a strain gauge according to an exemplary embodiment of the present invention. For example, a strain gauge 10 of a foil type may be attached to the hydrogen tank 2 to measure the strains in the directions of X and Y. The strain of X-direction detected by the strain gauge 10 on the hydrogen tank 2 may be a longitudinal strain of the hydrogen tank 2, and the strain of Y-direction may be a circumferential strain of the hydrogen tank 2. Thus, the expansion data, e.g., data about the strains of the longitudinal and circumferential directions of the hydrogen tank 2 may be obtained in real-time by the strain gauge 10 during the replenishment of hydrogen, and the safety state of the hydrogen tank 2 may be monitored using the strain/expansion data.

The strain gauge 10 may be fixed on the wall of the hydrogen tank 2 by various methods. For example, the strain gauge 10 may be embedded into the layer of the wall of the hydrogen tank 2. Specifically, when a reinforcing material such as carbon fiber is wound on the outer surface of the hydrogen tank 2, the strain gauge 10 may be attached to the main body of the hydrogen tank 2 or an inner layer of the reinforcing material wound on the hydrogen tank 2, and then the reinforcing material may be further wound, thereby affixing the strain gauge 10 to the hydrogen tank. In this case, a wire connected to the signal output unit of the strain gauge 10 may be connected to the vehicle-side control unit 20 such that signals (e.g., a strain signal) output from the strain gauge 10 can be input to the vehicle-side control unit 20.

The vehicle-side control unit 20 may convert electrical signal output from the strain gauge 10, that is, the strain signals measured during the replenishment of hydrogen, into signals that can be wirelessly transmitted by a vehicle-side wireless transmitter 31.

The wireless communication unit 30 may include a vehicle-side wireless transmitter 31 and a charging station-side wireless receiver 32. The wireless communication unit 30 may wirelessly transmit the real-time tank expansion data, e.g., the strain data measured in real-time by the strain gauge 10, and the real-time internal temperature and pressure of the hydrogen tank from the vehicle-side control unit 20 to the charging station-side control unit 41. Since the wireless communication unit 30 can perform data communication between the charging-side and the vehicle (more specifically, the hydrogen charger 40 of the charging station and the vehicle) without connection of a separate communication cable, the wireless communication unit 30 can save labor for connecting a connector of communication cable to the vehicle, facilitating the replenishment of hydrogen and therefore contributing to improvement of marketability of the vehicle.

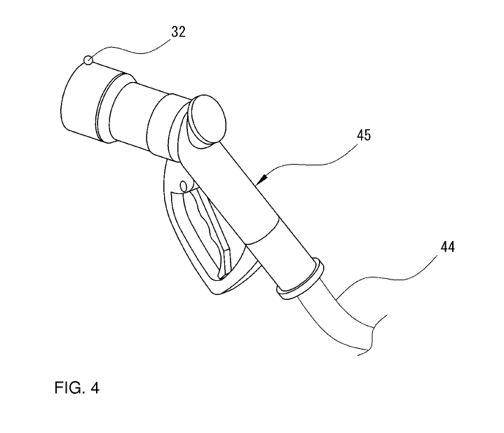

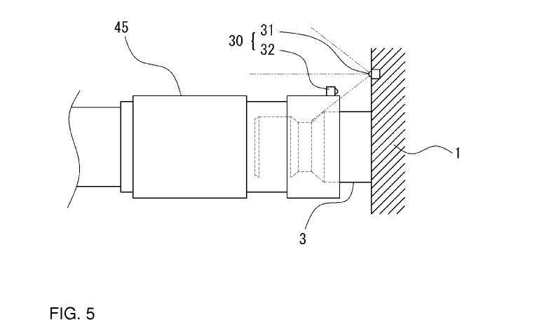

In an exemplary embodiment of the present invention, the wireless transmitter 31 and the wireless receiver 32 may be an IR transmitter and an IR receiver, respectively, which will be described with reference to FIGS. 4 and 5.

FIG. 4 is a perspective view illustrating a charging nozzle with an IR receiver according to an exemplary embodiment of the present invention. FIG. 5 is a view illustrating a charging nozzle of a hydrogen charger connected to a receptacle of the vehicle 1 according to an exemplary embodiment of the present invention.

As shown in FIGS. 4 and 5, a charging nozzle 45 may be connected to the end of a hydrogen supply hose 44 connected to the hydrogen charger (40 of FIGS. 1 and 2) at the charging station to supply hydrogen to the vehicle 1. An IR receiver 32 may be installed at one side of the charging nozzle 45 to receive data from the vehicle 1. An IR transmitter 31 for transmitting data to the charging station may be disposed in the vehicle 1 to wirelessly communicate with the IR receiver 32 when the charging nozzle 45 of the hydrogen charger (40 of FIGS. 1 and 2) is connected to the vehicle during the replenishment of hydrogen.

In an exemplary embodiment, the IR transmitter 31, as shown in FIG. 5, may be installed around a hydrogen charging aperture of the vehicle 1, e.g., around a receptacle 3 of the vehicle 1 that is connected to the charging nozzle 45. Thus, when the charging nozzle 45 is connected to the receptacle 3 of the vehicle 1, the IR transmitter 31 and the IR receiver 32 become mutually communicable. In this case, the tank expansion data may be delivered from the vehicle-side control unit 20 to the charging station-side control unit 41 through wireless data communication using the IR transmitter 31 and the IR receiver 32.

The charging station-side control unit 41 may be disposed in the hydrogen charger 40, and may perform a certain safety mode control process when receiving the real-time tank expansion data received by the IR receiver 32 to determine whether or not the tank expansion has exceeded a certain value.

The charging station-side control unit 41 may be provided to control the operation of the hydrogen supply unit 42 for supplying hydrogen to a vehicle, and may be connected to the IR receiver 32 through a cable, similar to the vehicle-side control unit 20 connected to the IR transmitter 31 through a cable.

The charging station-side control unit may determine whether unallowable tank expansion occurs, by comparing the strain data (e.g., the real-time tank expansion data) transmitted from a vehicle with a predetermined critical value for the vehicle or the particular hydrogen tank. When the strain data of the hydrogen tank detected in real-time by the strain gauge 10 exceeds the predetermined critical value, it is determined that unallowable tank expansion has occurred. In this case, the charging station-side control unit 41 may perform a safety mode control process of stopping/interrupting the replenishing operation of the hydrogen supply unit 42 and operating a warning unit 43 to issue a warning.

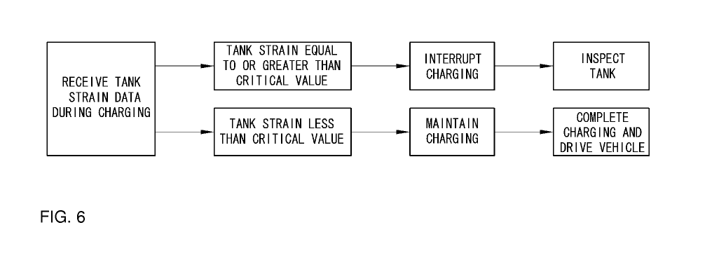

As shown in FIG. 6, when the strain of the tank is smaller than a critical value, the charging of hydrogen may be maintained. However, when the strain of the tank is equal to or greater than the critical value, the hydrogen charging operation of the hydrogen supply unit 42 may be interrupted, and simultaneously the warning unit 43 may be actuated to inspect the hydrogen tank 2.

The critical value may be established by a stress test in which strains are measured by a strain gauge until a tank having the same specifications is burst due to charging of high-pressure hydrogen. The critical value to be applied to a charging interruption logic may be determined based on the actual bursting strain, and include a margin for safe charging.

In the stress test, the tank body was manufactured using an aluminum alloy, and then wound with carbon fiber as a reinforcing material to manufacture a hydrogen tank of 700 bar. As shown in FIG. 3, the strain gauge was embedded in the carbon fiber layer of the hydrogen tank 2, and then high-pressure hydrogen was replenished into the hydrogen tank 2 until the hydrogen tank 2 burst. Also, the internal pressure (bursting pressure) of the tank and the bursting strain were measured when the hydrogen tank 2 burst.

As an example of the measurement result, the bursting pressure was measure to be about 1,388 bar, and the bursting strain was measured to be about 1.38%. Accordingly, an appropriate strain value lower than 1.38% may be set to the critical value.

Instead of determining the critical value using the bursting strain obtained from the above test on a hydrogen tank having the same specifications, the critical value may also be determined by data derived from numerical analysis using a finite element method. When a strain gauge capable of measuring strains in the longitudinal direction (X-direction) and circumferential direction (Y-direction) of a hydrogen tank is used, the critical value may be separately set to values with respect to each direction. If either X-directional strain or Y-directional strain reaches a predetermined critical value, the safety mode may be operated to interrupt the hydrogen charging and actuate the warning unit.

Also, when the internal pressure of the tank exceeds a certain value, a logic for interrupting the hydrogen charging and actuating the warning unit may be simultaneously applied. In this case, the certain value may also be set to a pressure value obtained from a test, for example, a value less than about 1,388 bar. For detailed description of the present invention, although it has been described that a strain gauge is used as an expansion measurement unit, the present invention is not limited thereto. For example, any one of a variety of known expansion measurement devices that may detect unallowable degrees of expansion by comparing an expansion degree of a tank with an initial value thereof may be adopted.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or over a Controller Area Network (CAN).

A system and method for safely charging hydrogen according to an exemplary embodiment of the present invention is configured to measure expansion of a hydrogen tank in real-time during hydrogen replenishment to allow a charging station to receive real-time expansion data of the tank from a vehicle through wireless communication. When the expansion data of the tank is determined to exceed a critical value, a safe mode control such as interruption of charging can be performed to prevent danger. Thus, according to an exemplary embodiment of the present invention, hydrogen can be more safely charged by stopping/interrupting hydrogen charging when it is determined that the tank expansion data received from a charging station through wireless communication exceeds a critical value. Also, the charging safety and tank reliability can be increased, and since the period of time between complete hydrogen tank inspections can be increased, cost for the total inspection can be reduced.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A system for monitoring real-time hydrogen tank expansion, comprising:
an expansion measurement unit disposed on a hydrogen tank, wherein the expansion measurement unit is configured to measure the degree of hydrogen tank expansion and output an expansion value signal;
a vehicle-side control unit configured to convert the expansion value signal into a wireless expansion value signal;
a charging station-side control unit configured to stop hydrogen replenishment when the wireless expansion value signal indicates an unsafe degree of tank expansion; and
a wireless communication unit provided to perform wireless data communication between the vehicle-side control unit and the charging-side control unit.

2. The system of claim 1, wherein the expansion measurement unit comprises a strain gauge.

3. The system of claim 2, wherein the strain gauge is disposed on a wall of the hydrogen tank.

4. The system of claim 2, wherein the strain gauge measures strains in a longitudinal direction and a circumferential direction of the hydrogen tank.

5. The system of claim 1, wherein the charging station-side control unit determines that the unsafe degree of tank expansion has occurred when the wireless expansion value signal reaches a predetermined critical value.

6. The system of claim 1, wherein the wireless communication unit comprises:
a wireless transmitter configured to transmit the wireless expansion value signal from the vehicle-side control unit; and
a wireless receiver for receiving the wireless expansion value signal from the wireless transmitter, and inputting the wireless expansion value signal to the charging station-side control unit.

7. The system of claim 6, wherein the wireless transmitter is an IR transmitter and the wireless receiver is an IR receiver.

8. The system of claim 7, wherein the IR transmitter is disposed around a hydrogen receiving receptacle of the vehicle.

9. The system of claim 7, wherein the IR receiver is disposed on one side of a hydrogen dispensing nozzle of the charging station.

10. A method for monitoring real-time hydrogen tank expansion, comprising:
measuring an expansion value of the degree of hydrogen tank expansion during hydrogen tank replenishment with an expansion measurement unit installed disposed on a hydrogen tank of a vehicle;
transmitting the expansion value from a vehicle-side control unit to a charging station-side control unit with a wireless communication unit; and
stopping hydrogen replenishment by a charging station-side control unit when the expansion value indicates an unsafe degree of tank expansion.

11. The method of claim 10, wherein the expansion measurement unit comprises a strain gauge.

12. The method of claim 11, wherein the strain gauge is disposed on a wall of the hydrogen tank and configured to measure a strain of the wall of the hydrogen tank during hydrogen replenishment.

13. The method of claim 11, wherein the strain gauge measures strains in a longitudinal direction and a circumferential direction of the hydrogen tank.

14. The method of claim 11, wherein the charging station-side control unit determines that the unsafe degree of tank expansion has occurred when the wireless expansion value signal reaches a predetermined critical value.

15. The system of claim 14, wherein the charging station-side control unit stops hydrogen replenishment.
